(19) United States
(12) Patent Application Publication
(10) Pub. No.: US 2010/0203292 A1
(43) Pub. Date: Aug. 12, 2010

(54) ANTISLIP SHEET MATERIAL HAVING TAPES AND MONOFILAMENTS

(75) Inventors: Manish K. Seth, Mission (CA); Martin Vido, Mission (CA)

Correspondence Address: KIRTON AND MCCONKIE, 60 EAST SOUTH TEMPLE,, SUITE 1800, SALT LAKE CITY, UT, 84111, US

(73) Assignee: IBCO SRL, St. Michael (BB)

(21) Appl. No.: 12/680,154

(22) PCT Filed: Nov. 5, 2008
(86) PCT No.: PCT/CA08/01937

§ 371 Date: Mar. 25, 2010

Related U.S. Application Data
(63) Continuation-in-part of application No. 60/985,617, filed on Nov. 5, 2007.

(51) Int. Cl. B32B 3/30

(52) U.S. Cl. 428/156

(57) ABSTRACT

A sheet material with an anti-skid surface, suitable for use as a roofing underlayment or wrapper, comprises a scrim made of woven plastic tapes with monofilaments that are round in cross-section and have a diameter larger than the thickness of the plastic tapes interwoven with the tapes. The monofilaments form ridges on the sheet material that impart an enhanced coefficient of friction to it. The monofilaments may be incorporated in the weave in the warp or weft directions or both.

### TECHNICAL FIELD OF THE INVENTION

The invention pertains to sheet materials made of plastic tapes, suitable for roofing, wrapping and other applications. More particularly, it pertains to such sheet materials having a surface with a high coefficient of friction.

### BACKGROUND OF THE INVENTION

Sheet materials comprising a scrim of woven plastic tapes are commonly used for roofing and wrapping applications. The sheet materials may be coated or uncoated. Such materials typically have a relatively smooth surface with a low coefficient of friction. For some applications, it is useful for the sheet material to have antislip properties. For example, if the sheet is to be applied to a roof deck, e.g. as a roofing underlayment, a surface with antislip properties on which workers may walk enhances worker safety. Likewise, if the sheet material is to be use to wrap goods such as bundles of lumber, on which workers may need to walk, an antislip surface is useful. The conventional methods of imparting antislip properties to sheet materials involve applying films, meshes or granules to the surface of the sheet.

### SUMMARY OF THE INVENTION

The invention provides a sheet material comprising a scrim made of woven plastic tapes which incorporates filaments, for example monofilaments, cords, wires, string, rope or burlap strings, inserted in the weave in the warp or weft or both directions, the filaments being round in cross-section and having a diameter larger than the thickness of the plastic tapes, forming ridges on the sheet material that impart an enhanced coefficient of friction to it. The sheet material provides enhanced slip-resistance in wet, dry or dusty conditions. The sheet material is useful for applications such as industrial wrapping, packaging and roofing underlayment.

According to one embodiment of the invention, there is provided a sheet of material having an anti-skid surface, comprising a first set of tapes generally parallel to each other, a second set of tapes generally parallel to each other and perpendicular to the first set of tapes, the tapes of the two sets being interwoven with each other to form a scrim. The tapes are extruded plastic having a width greater than their thickness. Filaments, for example monofilaments, generally parallel to the first set of tapes are positioned on the tapes of the first set and interwoven with the tapes of the second set. The filaments are round in cross-section and have a diameter greater than the thickness of the tapes and form ridges on the surface of the sheet.

### BRIEF DESCRIPTION OF THE DRAWINGS

FIG. 1 is a plan view of a sheet according to one embodiment of the invention.

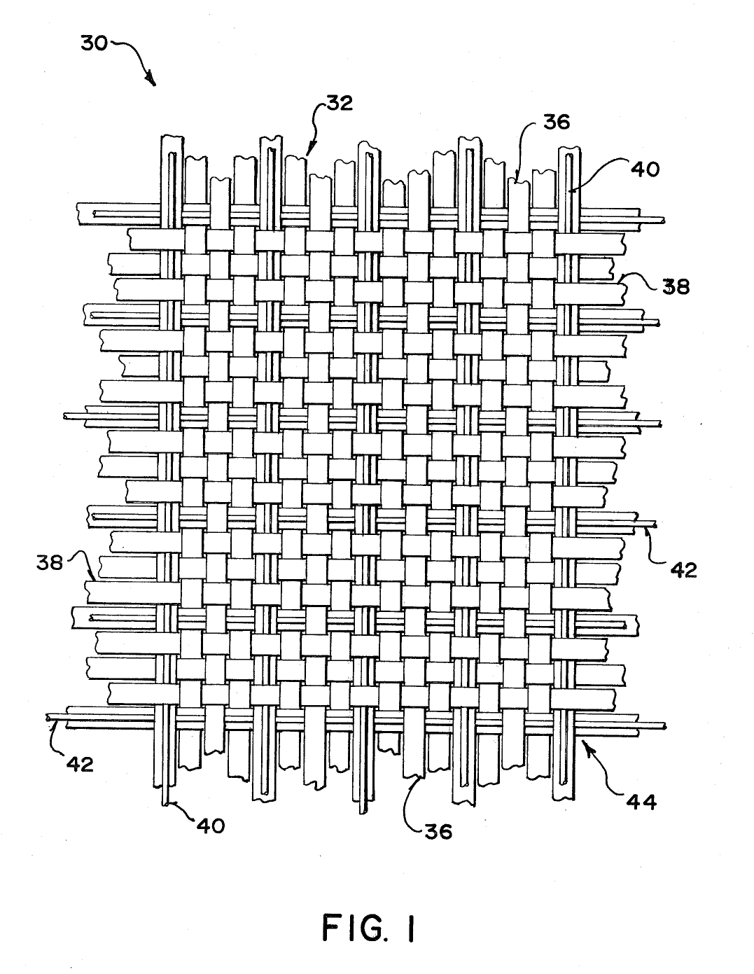

FIG. 2 is a plan view of a detail of the sheet.

FIG. 3 is a cross-sectional view on the line 3-3 of FIG. 2

### DETAILED DESCRIPTION OF THE PREFERRED EMBODIMENTS

Exemplary embodiments are illustrated in the referenced figures of the drawings. It is intended that the embodiments are to be considered illustrative rather than restrictive.

The sheet material 30 has a scrim 32 coated on one side by a coating layer 34. The scrim 32 is woven in a plain weave of warp tapes 36 and weft tapes 38. Warp monofilaments 40 and weft monofilaments 42 are incorporated into the structure of the scrim 32. In particular, the warp monofilaments 40 are positioned on respective warp tapes 36 and are interwoven with the weft tapes 38; and the weft monofilaments 42 are positioned on respective weft tapes 38 and are interwoven with the warp tapes 36 and with the warp monofilaments 40. This produces a grid 44 of woven monofilaments on one side of the scrim 32. The appearance of, the sheet 30 is accordingly that of two overlapping woven scrims, one made of tapes and one of monofilaments. The warp and weft tapes 36, 38 provide the overall strength of the fabric and they hold the monofilament grid 44 in position.

In the illustrated embodiments, the warp and weft monofilaments are positioned every fourth warp or weft tape, respectively. Alternatively, they may be positioned on every second, or third, etc. tape, or at selected other spacings.

The thickness of the tapes 36, 38 is typically about 1-2 mils (0.025 to 0.05 mm). The thickness (i.e. diameter) of the monofilaments 40, 42 is about 10-30 mils (0.25 to 0.76 mm), for example about 15 mils. The monofilaments accordingly produce ridges on the surface of the scrim 32, running in both the warp and weft directions, which provide an increased coefficient of friction to the sheet 30.

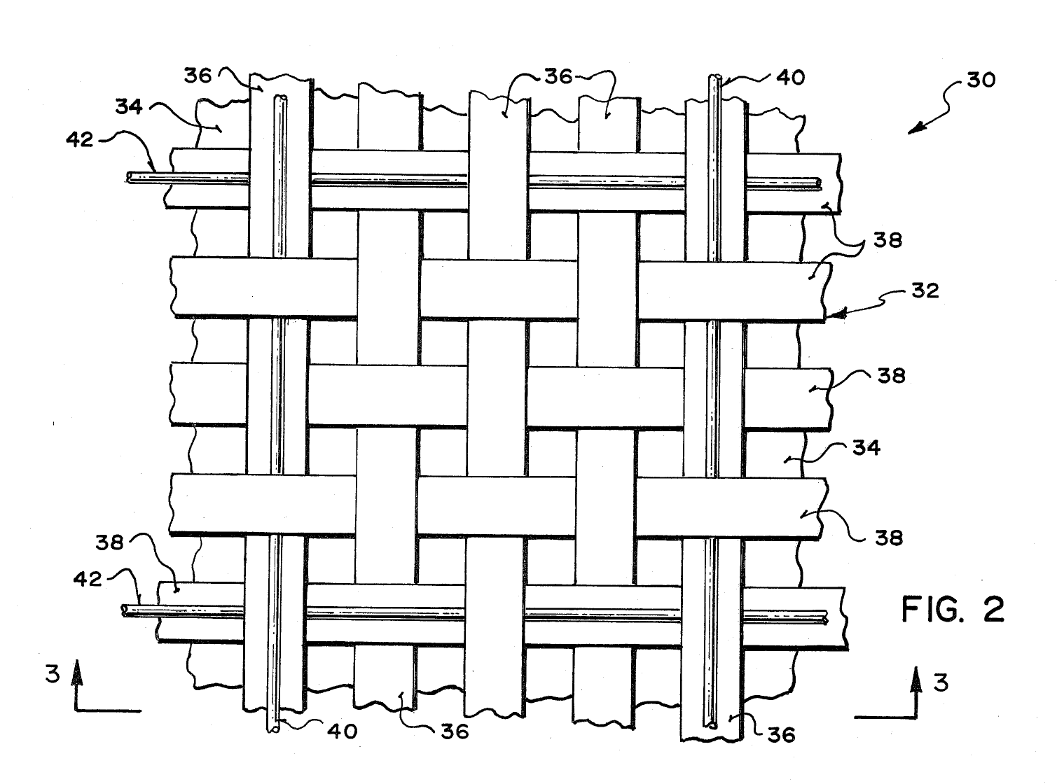

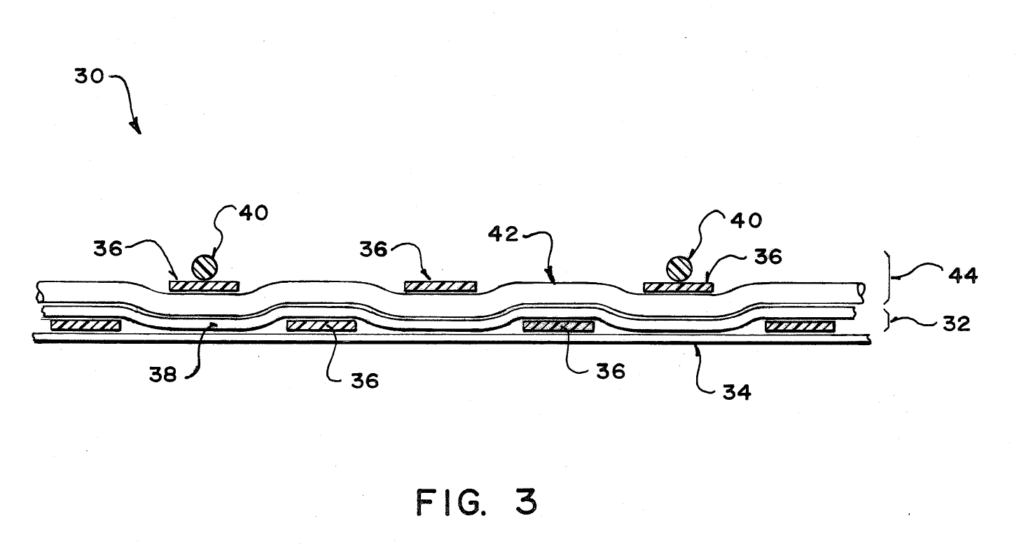

To form an effective anti-skid surface, the height of the ridges should be at least about six times greater than the thickness of the tapes, alternatively at least about twenty times greater. For purposes of clarity of illustration, in FIGS. 2 and 3 the thickness of the tapes 36, 38 is exaggerated; it is to be understood that the monofilaments form ridges of substantial thickness, relative to the much smaller thickness of the tapes 36, 38.

The monofilaments are woven in such a way that the weft monofilaments 42 pass under the warp monofilaments 40, as best seen in FIG. 2. This results in the warp monofilaments 40 being raised at their points of intersection, increasing the height of the ridges at those points. The denier of the monofilaments and the spacing of the monofilaments in the weave can be varied to achieve the desired coefficient of friction.

The scrim 32, coating 34 and tapes 36, 38 are made of plastic, preferably polyolefin resins, for example polyethylene or polypropylene. They may alternatively be made of various other plastics, including polyesters, polystyrene, nylon and ethylene acrylic copolymers. The tapes 36, 38 and/or the coating 34 may alternatively comprise a high coefficient-of-friction material, for example ethylene vinyl acetate (EVA), ethylene methyl acrylate (EMA), rubber or elastomer. The monofilaments are generally round in diameter and can likewise be made of any suitable plastic, including the same plastics as the rest of the sheet.

The tapes 36, 38 are preferably about 1.5 to 6 mm in width. The number of tapes per inch in the machine direction and in the cross direction is preferably in the range of 1 to 25.

The coating layer 34 (shown in FIGS. 2 and 3) is a waterproof film bonded to the scrim. It may be permeable to water vapor to allow the escape of moisture from buildings when the sheet is used as a roofing underlayment or for similar applications. The coating layer 34 is manufactured in-situ using an extrusion process and is laminated to the scrim 32, or it can comprise a film that is bonded to the scrim, for example by thermal bonding, lamination or adhesive. Optionally, a second coating layer is bonded to the opposite side of the scrim.

In embodiments of the sheet materials of the invention, the sheet can be uncoated, coated on one side or on both sides, or it can include additional layers, or can include monofilaments in only the warp direction or only the weft direction or in both directions. The color of the monofilaments can be the same as the surrounding tapes to blend in or it can be pigmented to make the antislip grid visible. The monofilaments or the coating, or both, can be treated with or comprise a tacky or high coefficient-of-friction coating or additive, for example, EVA, EMA, rubber or elastomer. These choices depend on the properties desired for a particular application.

In other embodiments of the invention, filaments other than monofilaments 40 are used. Examples of suitable materials include cords, wire, string, rope and strings of burlap. For purposes of recyclability of the sheet material, it is desirable that the filaments and the tapes be of the same composition, or at least of plastics material that can be recycled together. Accordingly, plastic monofilaments are preferred to these alternative materials.

Although the invention has been described in terms of various embodiments, it is not intended that the invention be limited to these embodiments. Various modifications within the scope of the invention will be apparent to those skilled in the art. The scope of the invention is defined by the claims that follow.

1. A sheet of material having an anti-skid surface, comprising:
a first set of tapes generally parallel to each other;
a second set of tapes generally parallel to each other and perpendicular to the first set of tapes;
the tapes being extruded plastic and having a width greater than their thickness;
the tapes of the first set and of the second set being interwoven with each other to form a scrim;
a first set of filaments generally parallel to the first set of tapes, each filament being positioned on a respective tape of the first set and interwoven with the tapes of the second set;
the filaments being generally round in cross-section and having a diameter greater than the thickness of the tapes and forming ridges on the surface of the sheet.

2. A sheet according to claim 1, further comprising a second set of filaments generally parallel to the second set of tapes, each filament of the second set being positioned on a respective tape of the second set and interwoven with the tapes of the first set and the filaments of the first set;
the filaments of the second set being round in cross-section and having a diameter greater than the thickness of the tapes and forming ridges on the surface of the sheet.

3. A sheet according to claim 1, wherein the filaments are monofilaments.

4. A sheet according to claim 1, wherein the filaments are one of cords, wires, string, ropes and burlap strings.

5. A sheet according to claim 1, wherein the tapes of the first set are warp tapes.

6. A sheet according to claim 1, wherein the tapes of the first set are weft tapes.

7. A sheet according to claim 1, wherein the scrim is a plain weave.

8. A sheet according to claim 1, wherein a respective filament of the first set of filaments is positioned on every fourth tape of the first set of tapes.

9. A sheet according to claim 1, wherein the filaments have a diameter at least six times greater than the thickness of the tapes.

10. A sheet according to claim 1, wherein the filaments have a diameter at least twenty times greater than the thickness of the tapes.

11. A sheet according to claim 1, wherein the thickness of the tapes is about 1 to 2 mils.

12. A sheet according to claim 1, wherein the diameter of the filaments is about 10 to 30 mils.

13. A sheet according to claim 1, wherein the tapes have a width in the range of 1.5 to 6 mm.

14. A sheet according to claim 3, wherein the tapes and monofilaments comprise polyolefin.

15. A sheet according to claim 3, wherein the tapes and monofilaments comprise one or more of polyethylene, polypropylene, polyester, polystyrene, nylon or ethylene acrylic polymer.

16. A sheet according to claim 1, further comprising a coating layer bonded to the scrim.

17. A sheet according to claim 1, wherein the filaments have a color that contrasts with the color of the tapes.

18. A sheet according to claim 1, wherein the filaments comprise a tacky or high coefficient-of-friction material.

19. A sheet according to claim 16, wherein the coating comprises a tacky or high coefficient-of-friction material.
